(19) United States
(12) Patent Application Publication
(10) Pub. No.: US 2011/0051044 A1
(43) Pub. Date: Mar. 3, 2011

(54) LIGHT QUANTITY CONTROL MEMBER, SURFACE LIGHT SOURCE UNIT AND DISPLAY DEVICE

(75) Inventor: Masaru SEGAWA, Kanagawa-ken (JP)

(73) Assignee: VICTOR COMPANY OF JAPAN, LIMITED, Yokohama-shi (JP)

(21) Appl. No.: 12/874,753

(22) Filed: Sep. 2, 2010

(30) Foreign Application Priority Data
Sep. 3, 2009 (JP) P2009-203797

(51) Int. Cl. G02F 1/13357; F21V 11/00; F21V 7/00

(52) U.S. Cl. 349/64; 362/355; 362/235

(57) ABSTRACT

A light quantity control member includes a light diffusion part formed by light diffusion members for diffusing light from a LED. The light diffusion part includes a first rectangular area positioned at the center of light flux from the LED and second rectangular areas positioned around the first rectangular area. The first rectangular area has an occupied area of the light diffusion members larger than any other second rectangular areas. If respective distances between a first center of the first rectangular area and respective second centers of the second rectangular areas are equal to each other, the occupied areas of the diffusion members of the second diffusion areas become equal to each other. The longer the distance between the first center of the first rectangular area and the second center of the second rectangular area gets, the smaller the occupied area of the light diffusion members of the second rectangular area becomes.

### BACKGROUND OF THE INVENTION

1. Field of the Invention

The present invention relates to a light quantity control member of a surface light source unit used in a non-self-luminous display device. More particularly, the invention relates to a light quantity control member of a surface light source unit using a point-like light source, such as LED (Light Emitting Diode), a surface light source unit using the above light quantity control member and a display device using the above surface light source unit.

2. Description of the Related Art

Conventionally, there is proposed a non-self-luminous display device, as typified by a liquid crystal display device. In this non-self-luminous display device, a surface light source unit (i.e. a backlight unit) is arranged on the backside of a liquid crystal display device, for illuminating it. As one of the conventional surface light source units, there is known a so-called “inland-type” surface light source unit which includes a diffusion plate whose back side allows an incidence of light from a light source and whose front side (emitting plane) allows the incident light to emit therefrom, as illumination light. In this surface light source unit, a plurality of light sources are opposed to the back side of the diffusion plate forming its incidence plane. Further, in the surface light source unit, light reflected toward the back side of the diffusion plate is reflected on a reflection sheet again and further returned to the incidence plate of the diffusion plate.

In the surface light source unit of inland-type, high light use efficiency of the light sources is obtained since the unit allows an incidence of light from the light sources through the back side of the diffusion plate and an emission of the light through the front side (emitting plane) of the diffusion plate with uniform diffusion. For the unit's growing in size, it is also possible to contemplate its weight saving by using a thin diffusion plate. Meanwhile, as the light sources are arranged so as to oppose the back side (incidence plane), it is difficult to reduce the thickness of the whole unit.

In the surface light source unit of inland-type, there are adopted linear light sources (e.g.

cold cathode fluorescent tubes) and point-like light sources (e.g. light emitting diodes), as the light source of the unit. Note that these light emitting diodes will be referred to as “LEDs” hereinafter. In case of the point-like light sources, such as LEDs, a plurality of point-like light sources are lined up apart from each other in a planate manner and arranged so as to oppose the back side (incidence plane) of the diffusion plate.

In the surface light source unit of inland-type, in front of the front side (emitting plane) of the diffusion plate, there are appropriately arranged a lens sheet that collects light (emitting light) emitted from the diffusion plate within a view angle thereby improving luminance and/or a diffusion sheet for contemplating uniformity of luminance.

If adopting the point-like light sources, such as LEDs, in the surface light source unit of inland-type, then it becomes possible to carry out so-called “local area control (local dimming)” operation. The local area control operation is a method of controlling luminance with respect to each area by narrowing down an amount of luminance of the light source corresponding to a dark area of an image, thereby accomplishing low-power consumption and high-contrast imaging.

In the conventional surface light source unit where a plurality of point-like light sources (e.g. LEDs) are lined up, however, luminance unevenness tends to take place corresponding to the position of the point-like light sources. The longer the interval among respective point-like light sources gets, the more remarkable the luminance unevenness becomes. Therefore, the surface light source unit has difficulty in facilitating the manufacturing process and reducing the manufacturing cost, as a result of reducing the number of point-like light sources by lengthening the interval among the point-like light sources.

In addition, if the surface light source unit utilizes light emitting diodes (LEDs) each emitting any monochromatic light in red, green or blue as the point-like light sources, it is necessary to produce high-purity incandescent light where respective color lights emitted from the respective diodes are mixed with each other. For this, it is also necessary to utilize a diffusion plate having an enough thickness and a light mixing chamber defining an enough space to allow respective lights emitted from the light emitting diodes for respective colors to be mixed with each other sufficiently.

In case of a surface light source unit of inland-type, the utilization of a diffusion plate having such a sufficient thickness and a light mixing chamber defining such a sufficient space would cause a thickness of the unit as a whole to be thickened. In addition, if making the diffusion plate having a sufficient thickness from plastic material, an optical loss is increased at a boundary between the inside of the diffusion plate and a surrounding material. Therefore, the adoption of a plastic diffusion plate would require growing number of light emitting diodes (LEDs), thereby causing the easiness in manufacturing, reduction in manufacturing cost and weight saving of the surface light source unit to be complicated.

In order to solve the problems mentioned above, there are known techniques disclosed in Japanese Patent Publication No. 4140569, Japanese Patent Publication Laid-open Nos. 2008-282744 and 2009-098607. In Japanese Patent Publication No. 4140569, there is disclosed an inland-type backlight unit for equalizing illumination light emitted from a number of light emitting diodes, which includes a first photochromic-dot group formed in an area generally equal to the outer diameter of LED and a second photochromic-dot group formed in an area larger than the outer diameter of LED, the first and second groups being provided with use of a diffusion pattern of light reflective ink formed in a transparent resinous substrate.

In Japanese Patent Publication Laid-open No. 2008-282744, there is disclosed an inland-type backlight unit which includes a dot pattern where dots having equalized areas in white pigment ink are scattered on a diffusion plate's surface opposed to the light source to restrain the luminance unevenness emitted from multiple light emitting diodes for realizing a thin backlight unit.

In Japanese Patent Publication Laid-open No. 2009-098607, there is disclosed a light diffusion body including a light diffusion part comprising a plurality of segments each having a high foam area and a low foam area wherein the light diffusion part is adapted so as to diffuse light broader by adjusting the low foam area in each segment.

### SUMMARY OF THE INVENTION

In the light quantity control member having a photochromic-dot pattern installed in the inland-type backlight unit of Japanese Patent Publication No. 4140569 or Japanese Patent Publication Laid-open No. 2008-282744, however, illumination unevenness trends to take place irrespective of the thickness of the surface light source unit and the arrangement of light sources. In particular, if progressing the thin-formation of the backlight unit, a circular pattern area would cause light to spread to only a circular surface light source.

In this way, if reducing the number of LEDs per unit area in view of productivity and manufacturing cost, the luminance unevenness becomes easy to occur. Especially, the luminance unevenness is most obvious for thinner backlight units of recent years. That is, there exists a trade-off relationship in between reduction of the number of LEDs and reduction of the thickness of backlight units. As for the technique disclosed in Japanese Patent Publication Laid-open No. 2009-098607, if multiple LEDs as point-like light sources are arranged in a lattice-pattern, then a distance between LEDs adjoined to each other in a diagonal direction gets longer than a distance between LEDs adjoined to each other in a vertical (or horizontal) direction, so that a segment positioned in an oblique direction to a central segment of diffusion would get dark in comparison with another segment positioned in the vertical (or horizontal) direction despite their identical distances from the central segment of diffusion. For this reason, the luminance unevenness is easy to occur.

Under the above-mentioned situation, an object of the present invention is to provide a light quantity control member for surface light source units, which could improve the luminance of illuminating light among respective point-like light sources to reduce the luminance unevenness in spite of reducing the number of point-like light sources and the thickness of a light mixing chamber, thereby accomplishing facilitation of the manufacturing process, reduction of the manufacturing cost and formation of the thin surface light source unit. Another object of the present invention is to provide a surface light source unit and a display device both having such a light quantity control member.

In order to achieve the above objects, according to the present invention, there is provided a light quantity control member comprising: a substrate; and a light diffusion part arranged on the substrate and also formed by a plurality of light diffusion members for diffusing light emitted from an external point-like light source, wherein the light diffusion part includes: a first rectangular area positioned at the center of light flux emitted from the point-like light source; and second rectangular areas in the circumference of the first rectangular area, and wherein the first rectangular area has the largest occupied area of the light diffusion members; the second rectangular areas are respectively formed so that if respective distances between a center of the first rectangular area and respective centers of the second rectangular areas are equal to each other, then the occupied areas of the diffusion members of the second rectangular areas become equal to each other; and each of the second rectangular areas is formed so that the longer the distance between the center of the first rectangular area and the center of the second rectangular area gets, the smaller the occupied area of the light diffusion members of the second rectangular area becomes.

In order to achieve the above objects, there is also provided surface light source unit comprising: a first point-like light source; and a light quantity control member arranged above the first point-like light source to have a light diffusion part formed by a plurality of light diffusion members for diffusing light emitted from the first point-like light source, wherein the light diffusion part includes: a first rectangular area positioned at the center of light flux emitted from the point-like light source; and second rectangular areas in the circumference of the first rectangular area, and wherein the first rectangular area has the largest occupied area of the light diffusion members; the second rectangular areas are respectively formed so that if respective distances between a center of the first rectangular area and respective centers of the second rectangular areas are equal to each other, then the occupied areas of the diffusion members of the second rectangular areas become equal to each other; and each of the second rectangular areas is formed so that the longer the distance between the center of the first rectangular area and the center of the second rectangular area gets, the smaller the occupied area of the light diffusion members of the second rectangular area becomes.

Still further, there is also provided a display device comprising: a surface light source unit including a first point-like light source and a light quantity control member arranged above the first point-like light source to have a light diffusion part formed by a plurality of light diffusion members for diffusing light emitted from the first point-like light source, wherein assuming that one rectangular area positioned at the center of light flux emitted from the first point-like light source is referred to as a first rectangular area, while a plurality of rectangular areas in the circumference of the first rectangular area are referred to as second rectangular areas, the first rectangular area has the largest occupied area of the light diffusion members; the second rectangular areas are respectively formed so that if respective distances between a first center of the first rectangular area and respective second centers of the second diffusion areas are equal to each other, then the occupied areas of the diffusion members of the second diffusion areas become equal to each other; and each of the second rectangular areas is formed so that the longer the distance between the first center of the first rectangular area and the second center of the second rectangular area gets, the smaller the occupied area of the light diffusion members of the second rectangular area becomes; and a liquid crystal panel having a plurality of pixels to control light irradiated from the surface light source unit with respect to each pixel.

### BRIEF DESCRIPTION OF THE DRAWINGS

FIG. 1A is an exploded perspective view showing the constitution of a surface light source unit to which a light quantity control member is applied in accordance with a first embodiment of the present invention and also showing the constitution of a non-self-luminous display device, and FIG. 1B is a side view of FIG. 1A;

FIG. 2A is a perspective view showing the arrangement of LEDs in the surface light source unit, FIG. 2B a perspective view of the arrangement where the light quantity control member is arranged above the LEDs, and FIG. 2C is a perspective view showing a diffusion pattern formed on a surface opposed to the LEDs of the light quantity control member;

FIG. 3A is a view showing a diffusion pattern of the light quantity control member in the surface light source unit of the first embodiment, FIGS. 3B and 3C respective enlarged views showing the diffusion pattern of the first embodiment, FIG. 3D a view showing the diffusion pattern of a conventional light quantity control member, and FIGS. 3E, 3F and 3G are respective enlarged views of the diffusion patterns for comparison;

FIG. 4A is an enlarged view showing the details of the diffusion pattern of the first embodiment, and FIG. 4B is a view explaining the relationship among center-to-center dimensions of respective diffusion areas;

FIG. 5A is a diagram showing a comparison of the luminance distribution at a light emission surface between the surface light source unit having the light quantity control member of the first embodiment applied thereto and the surface light source unit having the conventional light quantity control member applied thereto, and FIGS. 5B and 5C are views showing the measuring position of respective LEDs;

FIGS. 6A and 6B are luminance distribution diagrams at local areas of the surface light source unit where the light quantity control member of the first embodiment is arranged, FIGS. 6C and 6D luminance distribution diagrams at local areas of the surface light source unit where the conventional light quantity control member is arranged, and FIGS. 6E and 6F are luminance distribution diagrams at local areas of the surface light source unit where a diffusion plate having no light quantity control member is arranged;

FIG. 7 is a sectional view showing the constitution of the surface light source unit to which the light quantity control member of a first modification of the present invention is applied and also showing the constitution of the non-self-luminous display device;

FIG. 8 is a sectional view showing the constitution of the surface light source unit to which the light quantity control member of a second modification of the present invention is applied and also showing the constitution of the non-self-luminous display device;

FIG. 9A is a perspective view showing the arrangement of LEDs in the surface light source unit, FIG. 9B a perspective view of the arrangement where the light quantity control member is arranged above the LEDs, and FIG. 9C is a perspective view showing a diffusion pattern formed on a surface opposed to the LEDs of the light quantity control member;

FIGS. 10A, 10B, 10C and 10D are views showing the diffusion patterns of the light quantity control member of the second embodiment, and FIG. 10E is a view showing the diffusion pattern of the conventional light quantity control member;

FIGS. 11A, 11B, 11C and 11D are enlarged views showing the diffusion patterns of the light quantity control member of the second embodiment, and FIGS. 11E and 11F are enlarged views showing the conventional diffusion patterns;

FIG. 12A is a diagram showing a comparison of the luminance distribution at a light emission surface between the surface light source unit having the light quantity control member of the second embodiment applied thereto and the surface light source unit having the conventional light quantity control member applied thereto, and FIGS. 12B and 12C are views explaining the measuring position of respective LEDs;

FIGS. 13A and 13B are luminance distribution diagrams at local areas of the surface light source unit where the light quantity control member of the second embodiment is arranged, FIGS. 13C and 13D luminance distribution diagrams at local areas of the surface light source unit where the conventional light quantity control member is arranged, and FIGS. 13E and 13F are luminance distribution diagrams at local areas of the surface light source unit where a diffusion plate having no light quantity control member is arranged.

### DETAILED DESCRIPTION OF PREFERRED EMBODIMENTS

The light quantity control member, the surface light source unit and the display device in accordance with embodiments of the present invention will be described with reference to drawings, below.

### 1^{st} Embodiment

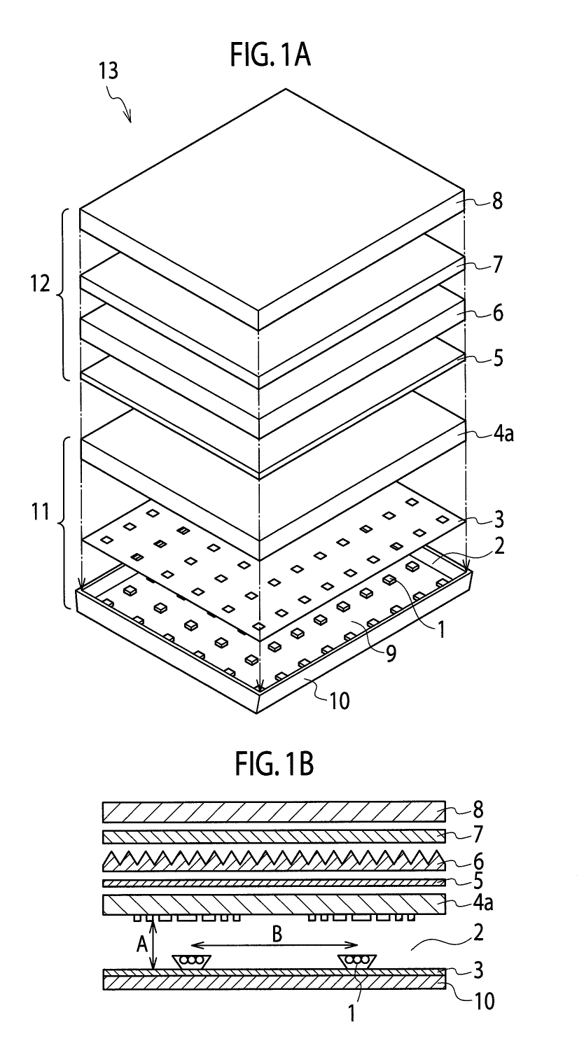

As shown in FIG. 1A, a non-self-luminous display device 13 includes a surface light source unit 11 and a non-self-luminous display unit 12 as an object to be illuminated by the surface light source unit 11. The surface light source unit 11 is used as an illuminating unit in the non-self-luminous display device 13.

The surface light source unit 11 includes a plurality of LEDs 1, a light mixing chamber 2 accommodating the LEDs 1 (a plurality of point-like light sources), a reflecting member 3, a light quantity control member 4a for controlling a transmitted light quantity and a reflective light quantity with respect to the light quantity emitted from the respective LEDs 1 and a chassis 10 consisting primarily of aluminum and having a backside inner wall to which the LEDs 1 are attached and a lateral inner wall succeeding to the backside inner wall. In operation, the surface light source unit 11 is adapted so as to illuminate the non-self-luminous display unit 12 on the side of the light quantity control member 4a (i.e. upside of FIG. 1A). At least part of respective inner walls (i.e. backside inner wall and lateral inner wall) of the light mixing chamber 2 is formed by a reflective surface.

The non-self-luminous display unit 12 includes a diffusion sheet 5 allowing an incidence of illumination light from the surface light source unit 11, a prism sheet 6 allowing an incidence of the illumination light transmitted through the diffusion sheet 5, a polarizing sheet 7 allowing an incidence of the illumination light transmitted through the prism sheet 6 and a transparent liquid crystal display panel 8 allowing an incidence of the illumination light transmitted through the polarizing sheet 7.

The diffusion sheet 5 has the characteristics of transmitting an incident light while being diffused with a designated directionality since the sheet 5 reduces the luminance unevenness while increasing a frontal luminance. The prism sheet 6 has the characteristics of transmitting an incident light while being diffused with a designated directionality since the same sheet 6 further increases the frontal luminance and horizontal luminance. The polarizing sheet 7 transmits the incident light in the form of linear polarized light in a designated direction. The liquid crystal display panel 8 includes a liquid crystal layer enclosed between a pair of transparent substrates. With an impressed drive voltage, the liquid crystal display panel 8 is adapted so as to arrays liquid crystal molecules in a predetermined direction and further modulate the incident light with respect to each pixel. With the impression of designated drive voltage with respect to each pixel, the liquid crystal display panel 8 modulates and transmits the incident light corresponding to the displayed image to display an image.

The multiple LEDs 1 are arranged apart from each other, in a lattice manner and attached to the backside inner wall of the light mixing chamber 2. The reflecting member 3 (white reflective sheet) has a plurality of openings formed to allow an insertion of the LEDs 1 and are arranged on a LED substrate 9, in opposition to the light quantity control member 4a. The reflecting member 3 may be formed by a while or silver substrate, sheet, tape or the like. Through the openings, the multiple LEDs 1 project from the reflecting member 3 toward the light quantity control member 4a. Both the reflecting member 3 and the light quantity control member 4a define the light mixing chamber 2. The light quantity control member 4a carries out surface-emitting by diffusing and reflecting the light emitted from the LEDs 1. More specifically, the light quantity control member 4a operates to make the luminance unevenness of the surface light source unit 11 less noticeable by diffusing the light emitted from the LEDs 1 to a plane direction.

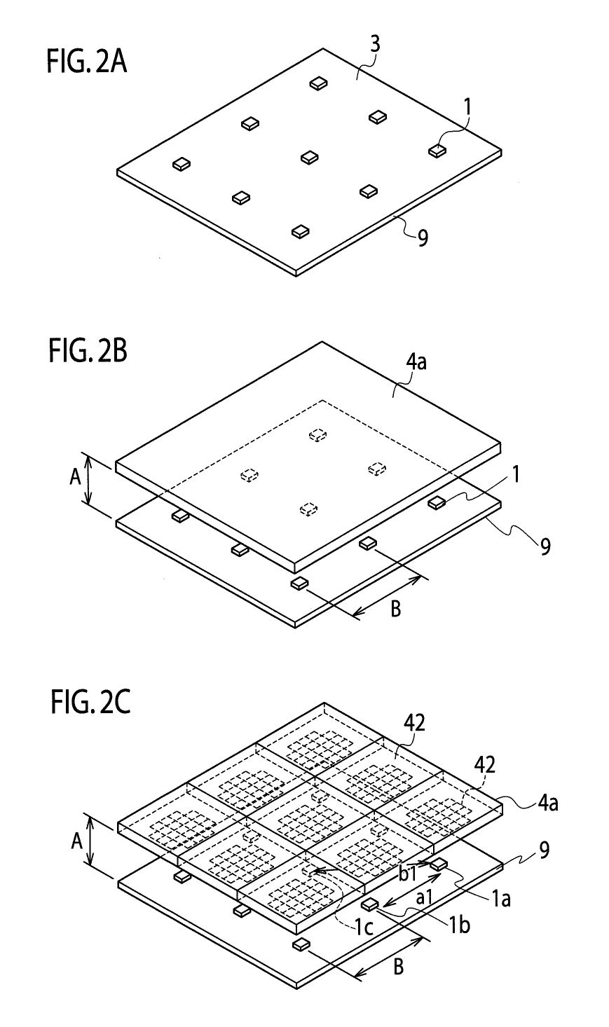

On the back surface of the light quantity control member 4a of the first embodiment shown in FIG. 2C (i.e. member's surface opposed to the LEDs 1 or the first surface), a diffusion pattern (light diffusing part) 42 for restraining the luminance unevenness is formed to accomplish the thin-formation of the surface light source unit 11 while restraining the reduction of luminance as possible, corresponding to each LED 1. Note that the diffusion pattern 42 may be formed on the front surface of the light quantity control member 4a. Alternatively, the diffusion pattern 42 may be formed on both front and rear surfaces of the member 4a.

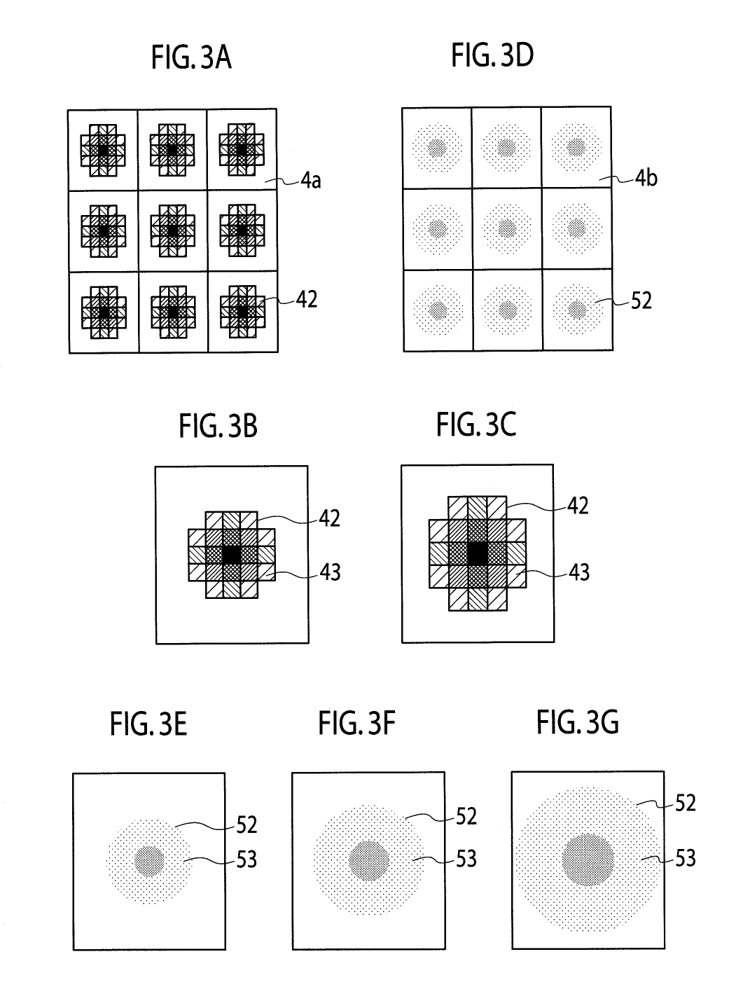

In the light quantity control member 4a shown in FIGS. 3A to 3C, the diffusion pattern 42 is shaped to be substantially rectangular and provided with respect to each LED 1. Further, the diffusion pattern 42 is divided into a plurality of rectangular diffusion areas (light diffusion areas) about the LED 1 as a center. In each diffusion area, there are formed a plurality of diffusion dots 43 (light diffusion members) exhibiting light reflectivity. In a conventional light quantity control member 4b for comparison, which is shown in FIGS. 3D to 3G, a diffusion pattern 52 is shaped to be circular. In the circular area, there are formed a plurality of diffusion dots 53 about the LED 1 as a center.

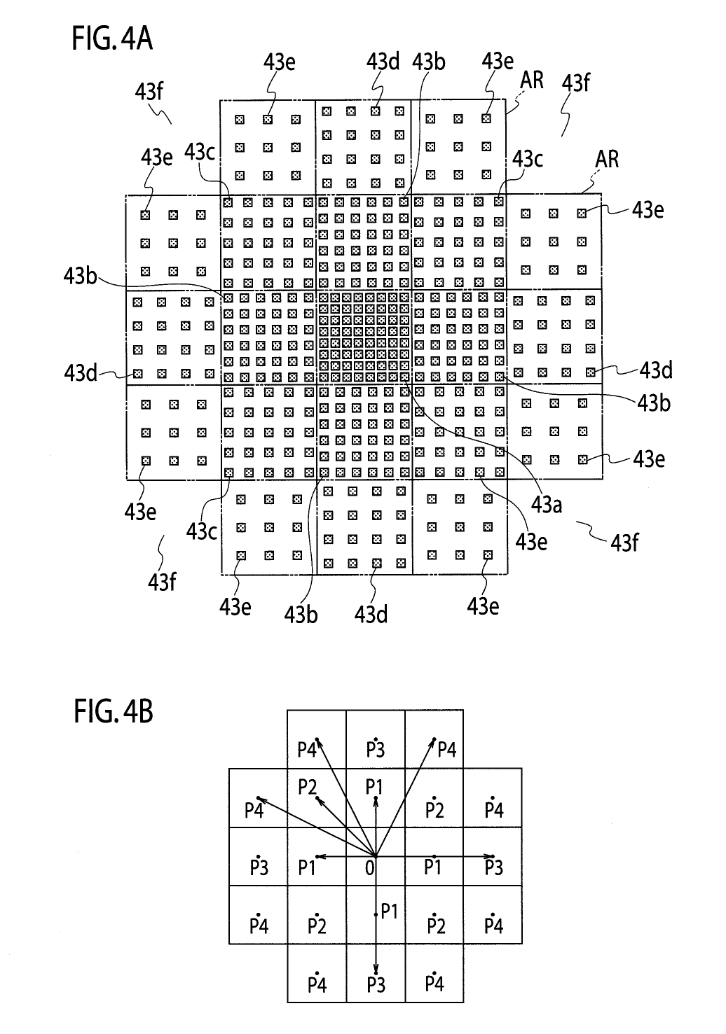

FIGS. 4A and 4B are enlarged views showing the details of the diffusion pattern 42 of the first embodiment of the invention. As shown in FIG. 4A, the diffusion pattern 42 is divided into a plurality of rectangular (square or oblong) diffusion areas AR of which areas are equal to each other and which includes a plurality of diffusion dots 43a to 43e. As shown in FIG. 4B, the diffusion pattern 42 is formed so that, in the diffusion area lying directly on the LED1 (i.e. a first rectangular area), an area occupied by the diffusion dots is larger than that of the other diffusion areas (i.e. the second rectangular areas) surrounding the first diffusion area. Regarding the second diffusion areas, specifically, the diffusion pattern 42 is formed so that if distances between the center O of the first rectangular area AR and respective centers of the second rectangular areas are equal to each other, then respective occupied areas of the diffusion dots in the second rectangular areas become equal to each other. Namely, if a first distance between the center O of the first rectangular area AR and the center of one second rectangular area is equal to a second distance between the center O of the first rectangular area AR and the center of another second rectangular area, the area occupied by the diffusion dots in the former second diffusion area becomes equal to the area occupied by the diffusion dots in the latter second rectangular area. In addition, the diffusion pattern 42 is formed in such a manner that the longer the distance between the center O of the first rectangular area AR and the center P1, P2, P3 or P4 of the other diffusion area AR gets, the smaller the area occupied by the diffusion dots included in the relevant other diffusion area becomes. Here, it is noted that the area occupied by the diffusion dots included in each diffusion area is defined as an occupied area of multiple diffusion dots 43a, 43b, 43c, 43d or 43e per unit area in each diffusion area AR. Note that the occupied area of the diffusion dots in the diffusion area may be adjusted by changing either the number of diffusion dots or the size of each diffusion dot.

Assume that the diffusion area AR having the diffusion dots 43a has an occupied area of diffusion dots represented by S1 (i.e. black portions in the figure) and an center represented by O. In four diffusion areas AR each having the diffusion dots 43b, similarly, their occupied areas of diffusion dots are respectively represented by S2, and respective centers are represented by P1. In four diffusion areas AR each having the diffusion dots 43c, their occupied areas of diffusion dots are respectively represented by S3, and respective centers are represented by P2. In four diffusion areas AR each having the diffusion dots 43d, their occupied areas of diffusion dots are respectively represented by S4, and respective centers are represented by P3. In eight diffusion areas AR each having the diffusion dots 43e, their occupied areas of diffusion dots are respectively represented by S5, and respective centers are represented by P4.

Under such an assumption, the occupied areas of diffusion dots S1 is larger the occupied areas of diffusion dots S2. While, the occupied areas of diffusion dots S2 is larger than the occupied areas of diffusion dots S3. The occupied areas of diffusion dots S3 is larger than the occupied areas of diffusion dots S4. While, the occupied areas of diffusion dots S4 is larger than the occupied areas of diffusion dots S5. The distance between the center O and the center P1 is shorter than the distance between the center O and the center P2. While, the distance between the center O and the center P2 is shorter than the distance between the center O and the center P3. The distance between the center O and the center P3 is shorter than the distance between the center O and the center P4. Note that respective corner area 43f contain no diffusion dot.

Besides the LED 1a, as shown in FIG. 2C, the LED substrate 9 further includes a LED 1b arranged at a distance al from the LED 1a in a “lattice-like” vertical or horizontal direction and a LED 1c arranged at a distance b1 (b1: >a) from the LED 1a in a lattice-like diagonal direction. In addition, as shown in FIGS. 4A and 4B, the above-mentioned other diffusion areas consist of first other diffusion areas AR adjacent to the diffusion area AR directly above the LED 1a in the vertical or horizontal direction and second other diffusion areas AR positioned in the diagonal direction of the diffusion area AR directly above the LED 1a. Under such an arrangement, the light diffusion pattern 42 is arranged so that the distances between the center O of the diffusion area AR directly above the LED 1a and respective centers P1, P3 of the first other diffusion areas AR become shorter than the distances between the center O of the diffusion area AR directly above the LED 1a and respective centers P2, P4 of the second other diffusion areas AR, respectively.

According to the diffusion pattern 42 shown in FIGS. 3A, 3B, 3C, 4A and 4B, light irradiated from the LEDs 1 is diffused by the diffusion dots 43a to 43e and also reflected against the reflecting member 3. While, in an area eliminating the diffusion dots 43a to 43e, light from the LEDs 1 is not diffused but irradiated as it is. The light reflected against the reflecting member 3 by the diffusion dots 43a to 43e is diffused toward the light quantity control member 4 by the reflecting member 3 again.

Repeatedly, the diffusion pattern 42 is formed so that, in the diffusion area directly above the LED1, its occupied area of the diffusion dots is larger than any occupied area of the diffusion dots of the other diffusion areas around the diffusion area AR directly above the LED 1. Regarding the other diffusion areas, specifically, the diffusion pattern 42 is formed so that if distances between the center O of the diffusion area AR and respective centers of the other diffusion areas are equal to each other, then respective occupied areas of the diffusion dots in the other diffusion areas become equal to each other. In addition, the diffusion pattern 42 is formed in such a manner that the longer the distance between the center O and the center P1, P2, P3 or P4 of the other diffusion area AR gets, the smaller the occupied area of the diffusion dots of the relevant other diffusion area becomes. That is, as the diffusion dots 43a to 43e are densely-arranged in respective high-intensity areas of the LEDs 1, the reflecting quantity of light can be increased in the high-density areas of the LEDs 1. While, as the diffusion dots 43a to 43e are sparsely-arranged in respective low-intensity areas of the LEDs 1, the reflecting quantity of light can be reduced in the low-intensity areas of the LEDs 1. Therefore, even if reducing the number of LEDs 1 and the thickness of the light mixing chamber 2, the luminance of an illumination light at respective positions among the LEDs 1 is improved to remove the illumination unevenness, accomplishing an easiness in manufacturing the surface light source unit, reduction in manufacturing cost and thin-formation of the surface light source unit.

So long as there is light reflectivity, there is no limitation for the diffusion dots 43 (43a to 43e). For the diffusion dots 43, there may be adopted, for example, light reflective ink containing white pigment, thin membrane made of aluminum or silver, coating medium containing these components and so on. In view of easiness of manufacturing, manufacturing cost and reflective performance, it is desirable to use the light reflective ink containing white pigment. Because, to contain a pigment in white means that the light reflective ink exhibits high reflectively against all visible light.

In case of using the light reflective link containing white pigment, there is no limitation for the concentration of white pigment since the diffusion pattern 42 is formed in accordance with the composition of light reflective ink. Again, the light reflective ink is composed of, for example, reflective agent (e.g. oxidized titanium), diffusion agent (e.g. as silica), adhesive agent (e.g. organic synthetic resin), etc.

Further, if the light reflective ink also contains lightproof agent and diffusion agent, then it is possible to diffuse and reflect incident light on the light quantity control member 4a by the lightproof agent and the diffusion agent, effectively. The light reflective ink containing the lightproof agent and the diffusion agent is produced by concocting a variety of ink raw materials at predetermined rates. For the lightproof agent, there may be used, for example, any of oxidized titanium, barium sulfide, calcium carbonate, oxidized silicon, oxidized aluminum, zinc oxide, nickel oxide, calcium hydroxide, lithium sulfide, ferrosoferric oxide, metacrylate resin powder, mica isinglass (Sericite), porcelain clay powder, kaolin, bentonite, gold powder, pulp fiber, etc. For the diffusion agent, there may be used, for example, any of oxidized silicon, glass beads, glass fine powder, glass fiber, liquid silicon, crystal powder, gold plating resin beads, cholesteric liquid crystal liquid, recrystallized acrylic resin powder, etc.

The diffusion dot 43 is produced by a variety of coating techniques, such as screen-printing method, a combination of vapor deposition with exposure development and so on.

In case of using the light reflective link containing white pigment, the light of the LEDs 1 irradiated on the diffusion dots 43 is reflected by the white pigment contained in the dots 43. That is, there is no limitation for the white pigment so long as it exhibits light reflectivity, as mentioned before.

Although the diffusion dot 43 of the first embodiment is formed so as to be a rectangular dot measuring 0.3 mm per side by the screen-printing method using the light reflective ink containing the white pigment, the size of the diffusion dot 43, its area and shape may be appropriately established in accordance with the composition and concentration of ink containing the white pigment, and there is no limitation for these parameters of the diffusion dot 43. Of course, the diffusion pattern 42 would be optimally designed in accordance with a suitable specification determined by various requirements, for example, light-emitting amount of each LED1, its orientation angle, interval B of respective LEDs 1, illumination area size to be controlled, composition of light reflective ink, etc.

Note that, as for the diffusion area directly above the LED1, of which occupied area of diffusion dots is the largest in the respective diffusion areas AR, the ratio of occupied area of diffusion dots may be set to 100%. In other words, the diffusion area AR directly above the LED1 may have all one pattern formed by the light reflective ink etc.

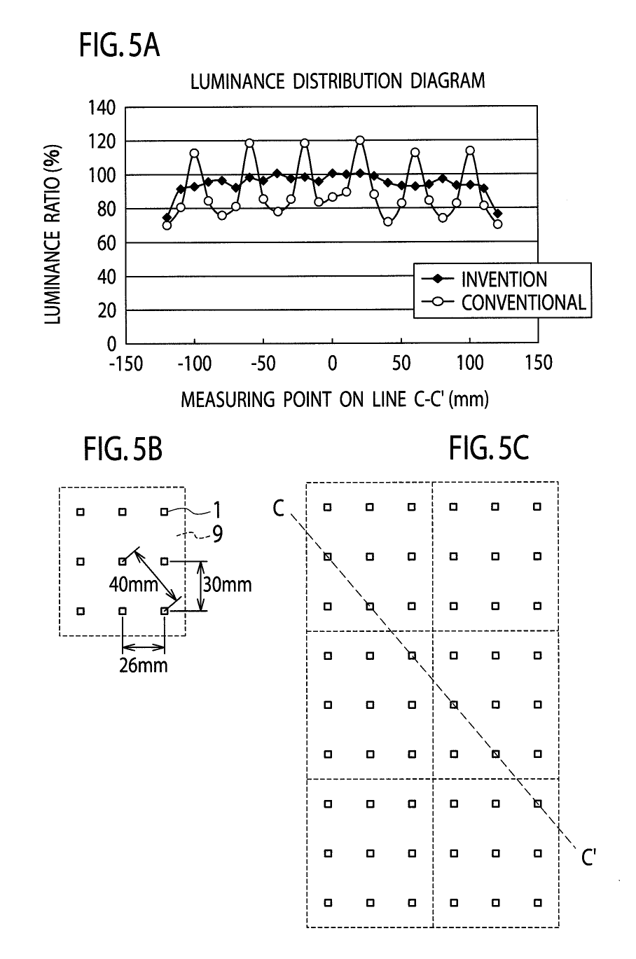

FIG. 5A is a diagram showing a comparison of the luminance distribution at a light emission surface between the surface light source unit on the application of the light quantity control member 4a of the first embodiment and the surface light source unit on the application of the conventional light quantity control member. FIG. 5A shows a comparison result of the luminance distribution at the light emission surface between the surface light source unit on the application of the light quantity control member 4a of the first embodiment and the surface light source unit on the application of the conventional light quantity control member, in case of narrowing a spatial distance A between the LEDs 1 and the reflecting member 3 (or the light quantity control member 4a) shown in FIGS. 2B and 2C, namely, narrowing the thickness of the light mixing chamber remarkably, for example, approx. 5mm.

In FIG. 5A, a horizontal axis designates measuring positions on a line C-C′ of FIG. 5C. The line C-C′ is identical to a line connecting one LED 1 with another LED adjoining the former LED 1 in the lattice-like diagonal direction. In FIG. 5A, the position of each peak of the conventional example shown with open circles (∘) corresponds to the position directly above each LED 1, while the position of each valley also shown with open circles (∘) corresponds to the position of one-half of an interval between the LED 1 and the adjoining LED 1 in the lattice-like diagonal direction. FIG. 5B shows the arrangement of respective LEDs 1 and intervals therebetween. The measurement was performed by using a spectral radiance luminance meter CS-1000 made by Konica-minolta Co. Ltd. in Japan.

Comparing the luminance distribution of the surface light source unit having the light quantity control member 4a of the first embodiment with the luminance distribution of the surface light source unit having the conventional light quantity control member, as shown in FIG. 5A, it is found that the luminance unevenness is obviously eliminated in the surface light source unit of the invention and furthermore, the homogenization of luminance distribution in an effective light emitting area is accomplished according to the invention.

It is noted that the surface light source unit 11 including the conventional light quantity control member having the diffusion pattern 52 of FIG. 3D formed therein requires the light mixing chamber 2 having a thickness of at least approx. 20 mm in order to homogenize the luminance distribution. In the surface light source unit 11 including the diffusion plate 4 avoiding the use of the conventional light quantity control member having the diffusion pattern 52 of FIG. 3D formed therein, additionally, it is required that the light mixing chamber 2 is formed with a thickness of approx. 40 mm to homogenize the luminance distribution.

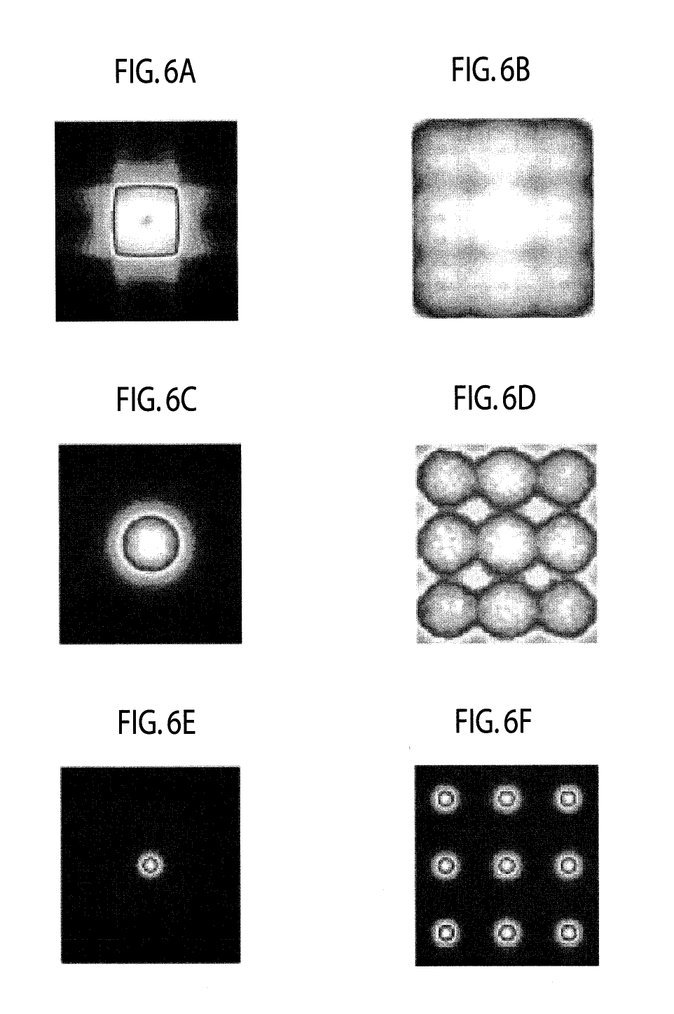

FIGS. 6A and 6B are luminance distribution diagrams at local areas of the surface light source unit having the light quantity control member of the first embodiment. FIGS. 6C and 6D are luminance distribution diagrams at local areas of the surface light source unit having the conventional light quantity control member. FIGS. 6E and 6F are luminance distribution diagrams at local areas of the surface light source unit having a diffusion plate having no light quantity control member.

FIGS. 6A, 6C and 6E show respective luminance distributions at a minimum area, while FIGS. 6B, 6D and 6F show respective luminance distributions at nine imaginary areas. The measurement was performed by using Pro Metric Color 1400 Luminance Measurement System made by Radiant Imaging Co. Ltd. in U.S.A. It is found that the luminance distribution at the minimum area spreads in a square manner, while the homogenization of luminance distribution is achieved in nine imaginary areas in the surface light source unit having the light quantity control member 4a of the first embodiment.

On the other hand, in the surface light source unit having the conventional light quantity control member, the luminance distribution at the minimum area spreads in a circular manner, so that the light from the LED 1 does not spread to four corners which are the farthest areas from the LED 1 in nine imaginary areas, sufficiently. It is also found that, in the surface light source unit having the diffusion plate, the light from the LED 1 does not spread as such due to narrowness of the spatial distance A between the LED 1 and the diffusion plate 4.

Note that the substrate forming the light quantity control member 4a is made of e.g. polycarbonate resin, acrylic resin, styrene resin, polyester resin, acrylic/styrene copolymerization resin or the like. As for the substrate of the light quantity control member 4a, there is no particular limitation for its material, its thickness, its haze value, etc.

The haze value is a parameter representing the degree of tarnish or the degree of diffusion. As the haze value becomes reduced in value, then the transmitted light becomes easier to see (For example, 20% in the haze value corresponds to 80% in transmissivity). Conversely, the larger the haze value gets, the larger the quantity of diffused light gets, so that the transmitted light becomes more difficult to see (For example, 80% in the haze value corresponds to 20% in transmissivity). That is, if increasing the haze value, then the diffusion effect is enhanced.

A solid-state light emitting element is available for the point-like light source of the surface light source unit 11. For instance, besides the LED 1, an electroluminescence element (EL) etc. may be used for the point-like light source of the surface light source unit 11. In addition, for these multiple point-like light sources, it is desirable to adopt so-called “three-in-one” or “four-in-one” type RGB-LEDs where respective LEDs 1 for emitting monochromatic lights of red, blue and green are installed into one package, in view of maintaining the color purity of white advantageously. If using a LED 1 emitting a monochromatic light as each point-like light source, there are recommended AlGaAs, AlGaInP or GaAsP for the material of the LED 1 for red light, InGaN or AlGaInP for the material of the LED 1 for green light and InGaN for the material of the LED 1 for blue light.

Preferably, the reflecting member 3 has a high reflectivity against a visible light. For instance, there are advantageously used a white sheet (or tape), which can be produced by stretching a plastic film or simply foaming it, silver-plated aluminum foil (or resin material), white-painted aluminum foil (or resin material), etc. for the reflecting member 3.

As described above, according to the light quantity control member 4a of the first embodiment, the diffusion pattern 42 is divided into a plurality of rectangular diffusion areas AR each having a plurality of diffusion dots 43a to 43e. In addition, the diffusion pattern 42 is formed so that, in the diffusion area directly above the LED1, its occupied area of the diffusion dots is larger than any occupied area of the diffusion dots of the other diffusion areas around the diffusion area directly above the LED 1. Regarding the other diffusion areas, specifically, the diffusion pattern 42 is formed so that if distances between the center O of the diffusion area AR directly above the LED 1 and respective centers of the other diffusion areas are equal to each other, then respective occupied areas of the diffusion dots in the other diffusion areas become equal to each other. In addition, the diffusion pattern 42 is formed in such a manner that the longer the distance between the center O and the center P1, P2, P3 or P4 of the other diffusion area AR gets, the smaller the occupied area of the diffusion dots 43a to 43e of the relevant other diffusion area AR becomes. Therefore, according to the first embodiment, since the light quantity control member 4a enables the light fluxes emitted from the LEDs 1 to be transmitted therethrough with diffusion, it is possible to produce an effect of making a square-shaped surface light source. In addition, even if reducing the number of LEDs 1 and the thickness of the light mixing chamber 2, the luminance of an illumination light at respective positions among the LEDs 1 is improved to remove the illumination unevenness, accomplishing an easiness in manufacturing the surface light source unit, reduction in manufacturing cost and thin-formation of the surface light source unit.

Under condition that a distance al between a certain LED 1a of the multiple LEDs 1 and an adjoining LED 1b in the lattice-like vertical or horizontal direction is smaller than a distance b1 between the above LED 1a and an adjoining LED 1c in the lattice-like diagonal direction, the diffusion areas forming the diffusion pattern 42 are arranged so that respective sides of each rectangular area extends in the lattice-like vertical or horizontal direction. Further, the area occupied by the diffusion dots 43 on the side of the LED 1c adjoining the LED 1a in the lattice-like diagonal direction is smaller than the area occupied by the diffusion dots 43 on the side of the LED 1b adjoining the LED 1a in the lattice-like vertical or horizontal direction. Therefore, as the light's tendency of being diffused toward the LED 1c is enhanced in comparison with the light's tendency of being diffused toward the LED 1b, the above effect of making a square-shaped surface light source is increased furthermore.

In the surface light source unit having the light quantity control member 4a of the first embodiment, additionally, the illumination light can be supplied to even each interval between the adjoining LEDs 1, which is apt to get dark comparatively, and also four corners of the unit, which are farthest from the LEDs 1. Thus, the luminance unevenness is resolved to attain the homogenization of luminance distribution in an effective luminous area and furthermore, it is possible to reduce the thickness of the light mixing chamber 2 with no performance deterioration and also increase an interval B between the adjoining LEDs 1. In other words, it is possible to reduce the number of indispensable LEDs 1 for a designated performance in comparison with that of the prior art surface light source having the conventional light quantity control member, enabling a reduction of the manufacturing cost of the unit.

Further, if the surface light source unit is provided with LEDs for emitting red, blue and green monochromatic lights as the multiple point-like light sources, then the light quantity control member 4a of the first embodiment can mix respective lights emitted from the respective LEDs 1 more effectively, allowing high-purity white color to be displayed on the unit.

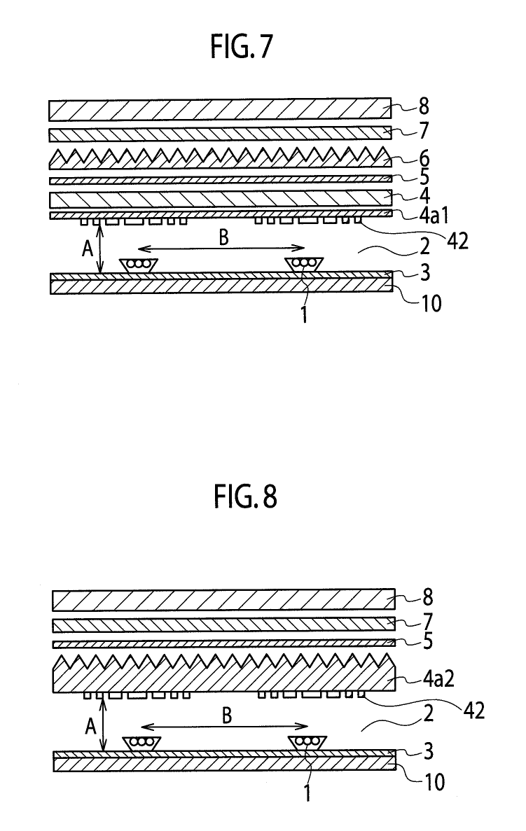

FIG. 7 is a sectional view showing the constitution of the surface light source unit on the application of the light quantity control member of a first modification of the present invention and also showing the constitution of the non-self-luminous display device. In the light quantity control member 4a 1 of FIG. 7, a diffusion pattern 42 is formed on the underside of the diffusion plate 4.

FIG. 8 is a sectional view showing the constitution of the surface light source unit on the application of the light quantity control member of a second modification of the present invention and also showing the constitution of the non-self-luminous display device. The light quantity control member 4a2 of FIG. 8 comprises a diffusion plate having prisms formed on the light-emission side and a diffusion pattern 42 formed on the backside.

Note that the constitution of optical sheets to be interposed between the liquid crystal display panel 8 is not limited to only those shown in FIGS. 7 and 8 and therefore, the constitution of optical sheets may be determined in accordance with a designated specification appropriately.

Also, by the light quantity control members 4a1, 4a2 of the first and second modifications, there can be realized an effect of producing such a square-shaped surface light source as that of the first embodiment since they (i.e. the members 4a1, 4a2) can transmit respective light fluxes emitted from the LEDs 1 while diffusing them.

### 2^{nd}. Embodiment

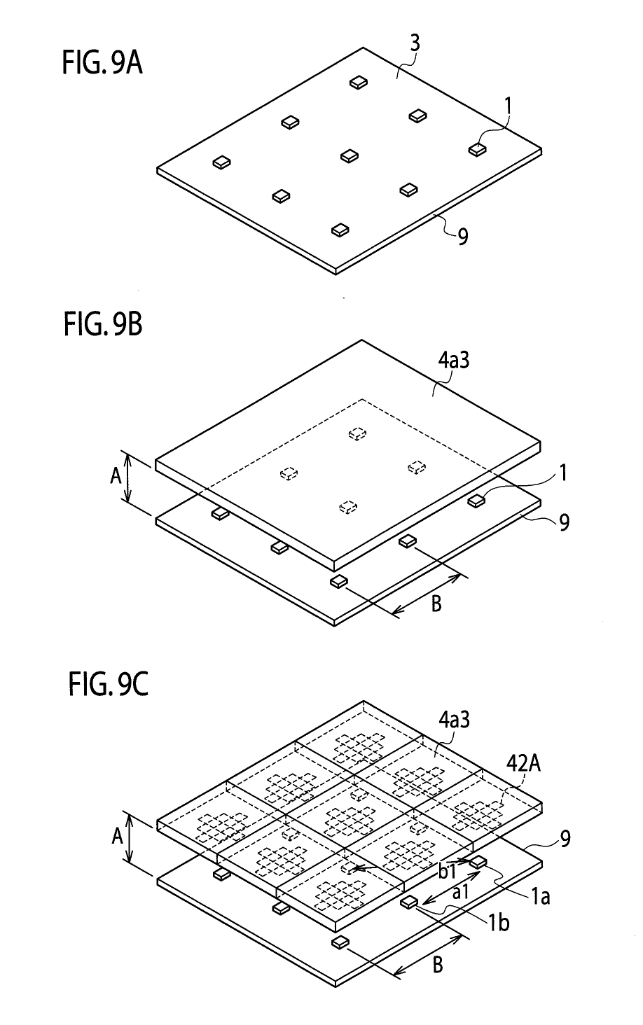

Next, the light quantity control member, the surface emitting unit and the display device in accordance with the second embodiment of the present invention will be described with reference to FIGS. 9A to 13F.

According to the second embodiment, in view of reducing the spatial distance A, a light quantity control member 4a 3 is provided, on its back surface (i.e. surface opposed to the LEDs 1), with diffusion patterns 42A corresponding to the LEDs 1 respectively, as shown in FIG. 9C. With the suppression of luminance unevenness, these diffusion patterns 42A are intended to restrain the reduction of luminance as possible, besides thin-formation of the surface light source unit. Note that the diffusion patterns 42A may be formed on the front surface of the light quantity control member 4a3. Alternatively, the diffusion patterns 42A may be formed on both front and rear surfaces of the member 4a3.

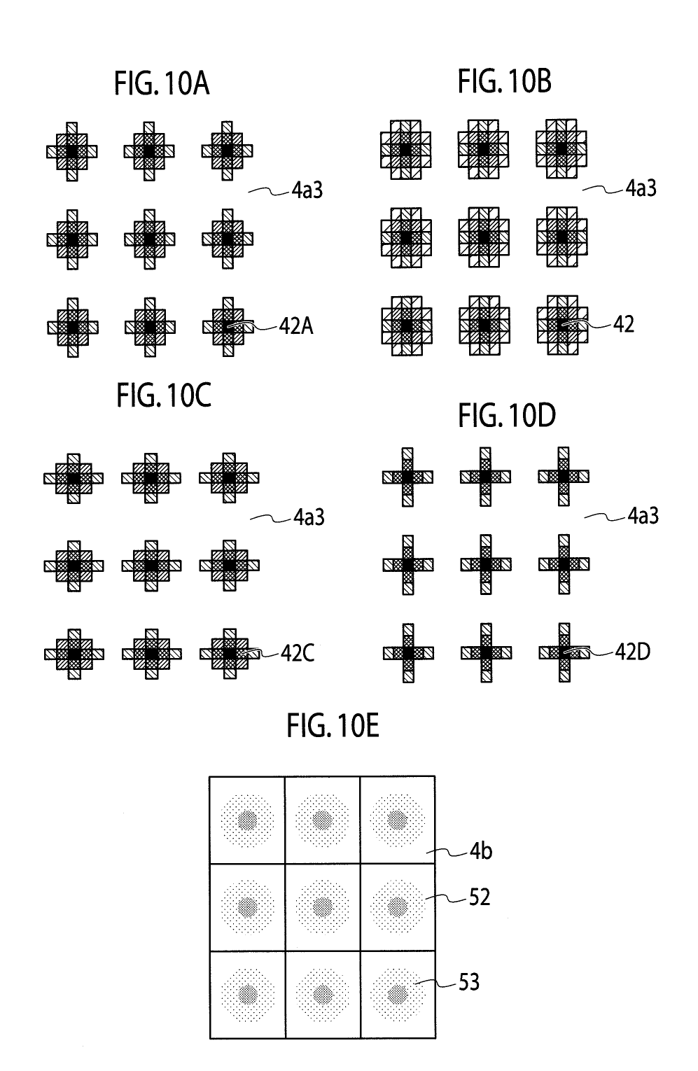

Besides the LED 1a, as shown in FIG. 9C, the LED substrate 9 further includes a LED 1b arranged at a distance a1 from the LED 1a in a “lattice-like” vertical or horizontal direction and a LED 1c arranged at a distance b1 (b1: >a1) from the LED 1a in a lattice-like diagonal direction. In addition, as shown in FIGS. 10A and 10B, the above-mentioned other diffusion areas consist of first other diffusion areas AR adjacent to the diffusion area AR directly above the LED 1a in the vertical or horizontal direction and a second other diffusion area AR positioned in the diagonal direction of the diffusion area AR directly above the LED 1a. Under such an arrangement, the light diffusion patterns 42A, 42C are arranged so that the distances between the center O of the diffusion area AR directly above the LED 1a and respective centers P1, P3 of the first other diffusion areas AR become shorter than the distance between the center O of the diffusion area AR directly above the LED 1a and the center P2 of the second other diffusion area AR, respectively.

It is noted that the second embodiment differs from the first embodiment in terms of the diffusion pattern 42 of the light quantity control member 4a3 only, while the other constitution of the former embodiment is identical to that of the latter embodiment. Therefore, we now describe only the diffusion pattern 42 and the other descriptions are eliminated.

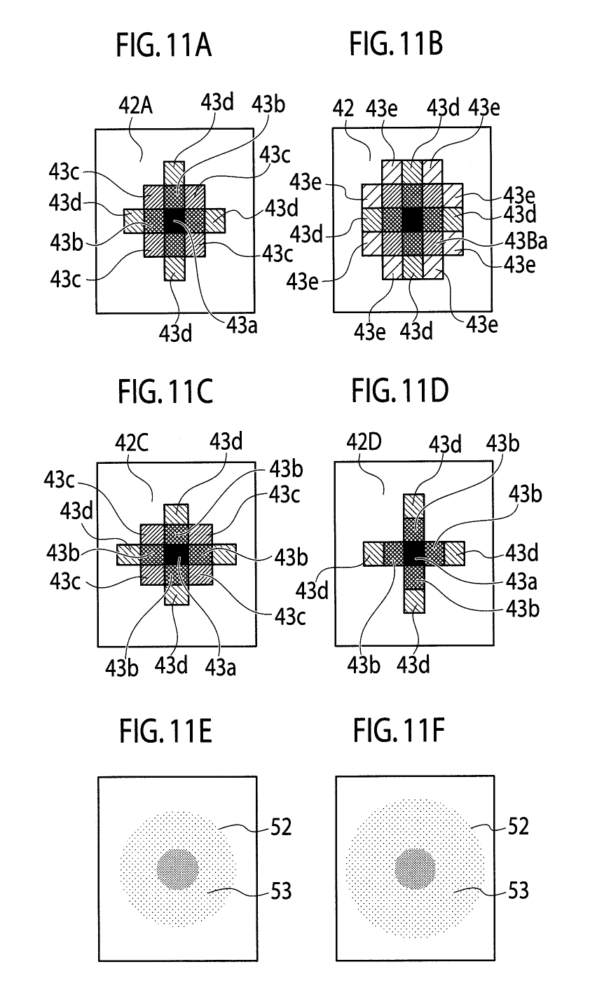

FIGS. 10A to 10D are respective views showing the diffusion patterns 42A, 42, 42C and 42D of the light quantity control member 4a3 of the surface light source unit. FIGS. 11A to 11D are respective enlarged views showing the diffusion patterns 42A, 42, 42C and 42D of the second embodiment. FIG. 10E is a view showing the diffusion pattern 52 of the conventional light quantity control member. FIGS. 11E and 11F are enlarged views of the conventional diffusion pattern 52.

Note that, as the diffusion pattern 42 of FIGS. 10B and 11B is identical to the diffusion pattern 42 of FIG. 4A, the description of the pattern is eliminated.

As shown in FIG. 11A, the diffusion pattern 42A is equivalent to one obtained by removing eight areas AR of the diffusion dots 43e from the diffusion pattern 42 of FIG. 11B. In the diffusion pattern 42A, a plurality of diffusion dots 43a to 43d are formed in respective diffusion areas. These diffusion areas including the diffusion dots 43b to 43d are arranged in a cross shape about the diffusion area including the diffusion dot 43a as a center.

As shown in FIG. 11C, the diffusion pattern 42C is constructed substantially similarly to the diffusion pattern 42A of FIG. 11A. However, the difference is that the diffusion pattern 42A is a pattern elongated in the vertical direction, while the diffusion pattern 42 is a pattern elongated in the horizontal direction.

As shown in FIG. 11D, the diffusion pattern 42D is equivalent to one obtained by removing four areas AR of the diffusion dots 43c from the diffusion pattern 42A of FIG. 11A. In the diffusion pattern 42D, a plurality of diffusion dots 43a, 43b and 43d are formed in respective diffusion areas. These diffusion areas including the diffusion dots 43b, 43d are arranged in a cross shape about the diffusion area including the diffusion dot 43a as a center.

Each of these diffusion patterns 42A, 42C and 42D is formed so that, in the diffusion area directly above the LED1, its occupied area of the diffusion dots is larger than any occupied area of the diffusion dots of the other diffusion areas around the diffusion area directly above the LED 1. As for the other diffusion areas, additionally, each diffusion pattern 42A (42C, 42D) is formed so that if respective distances between the center O of the diffusion area AR directly above the LED1 and respective centers of the other diffusion areas are equal to each other, then the occupied area of the diffusion dots included in the other diffusion area become equal to each other. Namely, if a first distance between the center O of the diffusion area AR directly above the LED1 and the center of one other diffusion area is equal to a second distance between the center O of the diffusion area AR and the center of another of the other diffusion area, the occupied area of the diffusion dots included in the former other diffusion area becomes equal to the occupied area of the diffusion dots included in the latter other diffusion area. In addition, the diffusion pattern 42A (42C, 42D) is formed in such a manner that the longer the distance between the center O and the center of the other diffusion area gets, the smaller the occupied area of the diffusion dots 43a to 43e of the relevant other diffusion area becomes.

As shown in FIG. 10E, the conventional light quantity control member 4b for comparison is provided with a plurality of circular-shaped diffusion patterns 52 each of which has a number of diffusion dots 53 formed within a circular area, around the LED 1 as a center.

In the diffusion patterns 42A, 42C and 42D shown in FIGS. 10A, 10C, 10D, 11A, 11C and 11D, light emitted from the LEDs 1 is diffused by the diffusion dots 43a to 43e and also reflected against the reflecting member 3. While, in the area where the diffusion dots 43a to 43e are not formed, the light emitted from the LEDs 1 is not diffused by the area but irradiated as it is. The light reflected against the reflecting member 3 by the diffusion dots 43a to 43e is again diffused toward the light quantity control member 4a3 by the reflecting member 3.

Each of these diffusion patterns 42A, 42C and 42D is formed so that, in the diffusion area directly above the LED1, its occupied area of the diffusion dots is larger than any occupied area of the diffusion dots of the other diffusion areas around the diffusion area directly above the LED1. As for the other diffusion areas, additionally, each diffusion pattern 42A (42C, 42D) is formed so that if respective distances between the center O of the diffusion area AR directly above the LED1 and respective centers of the other diffusion areas (e.g. two distances between the center O and respective centers of two other diffusion areas) are equal to each other, then the occupied area of the diffusion dots included in the former other diffusion area becomes equal to that occupied area of the diffusion dots included in the latter other diffusion area. In addition, the diffusion pattern 42A (42C, 42D) is formed in such a manner that the longer the distance between the center O and the center of the other diffusion area gets, the smaller the occupied area of the diffusion dots 43a to 43e of the relevant other diffusion area becomes. That is, as the diffusion dots are densely-arranged in respective high-intensity areas of the LEDs 1, the reflecting quantity of light can be increased in the high-density areas of the LEDs 1. While, as the diffusion dots are sparsely-arranged in respective low-intensity areas of the LEDs 1, the reflecting quantity of light can be reduced in the low-intensity areas of the LEDs 1. Therefore, even if reducing the number of LEDs 1 and the thickness of the light mixing chamber 2, the luminance of an illumination light at respective positions among the LEDs 1 is improved to remove the illumination unevenness, accomplishing an easiness in manufacturing the surface light source unit, reduction in manufacturing cost and thin-formation of the surface light source unit.

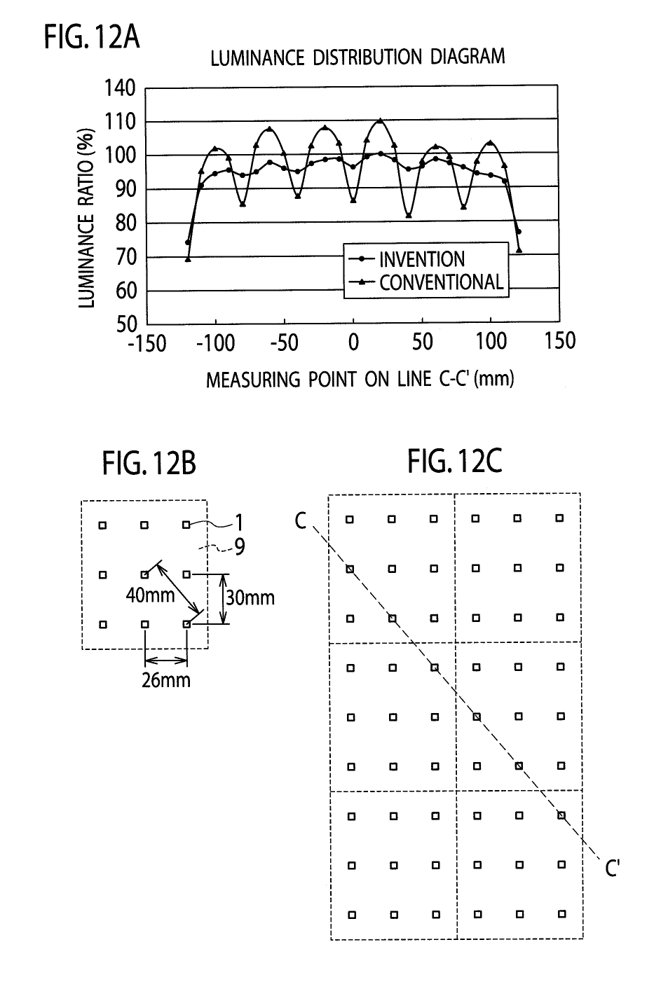

FIG. 12A is a diagram showing a comparison of the luminance distribution at a light emission surface between the surface light source unit on the application of the light quantity control member 4a3 of the second embodiment and the surface light source unit on the application of the conventional light quantity control member. FIG. 12A shows a comparison result of the luminance distribution at the light emission surface between the surface light source unit having the light quantity control member 4a3 of the first embodiment and the surface light source unit having the conventional light quantity control member, in case of narrowing a spatial distance A between the LEDs 1 and the reflecting member 3 (or the light quantity control member 4a3) shown in FIGS. 9B and 9C, namely, narrowing the thickness of the light mixing chamber remarkably, for example, approx. 4 mm.

In FIG. 12A, a horizontal axis designates measuring positions on a line C-C′ of FIG. 12C. The line C-C′ is identical to a line connecting one LED 1 with another LED adjoining the former LED 1 in the lattice-like diagonal direction. In FIG. 12A, the position of each peak of the conventional example shown with black triangles (▴) corresponds to the position directly above each LED 1, while the position of each valley also shown with black triangles (▴) corresponds to the position of one-half of an interval between the LED 1 and the adjoining LED 1 in the lattice-like diagonal direction. FIG. 12B shows the arrangement of respective LEDs 1 and intervals therebetween. The measurement was performed by using a spectral radiance luminance meter CS-1000 made by Konica-minolta Co. Ltd. in Japan.

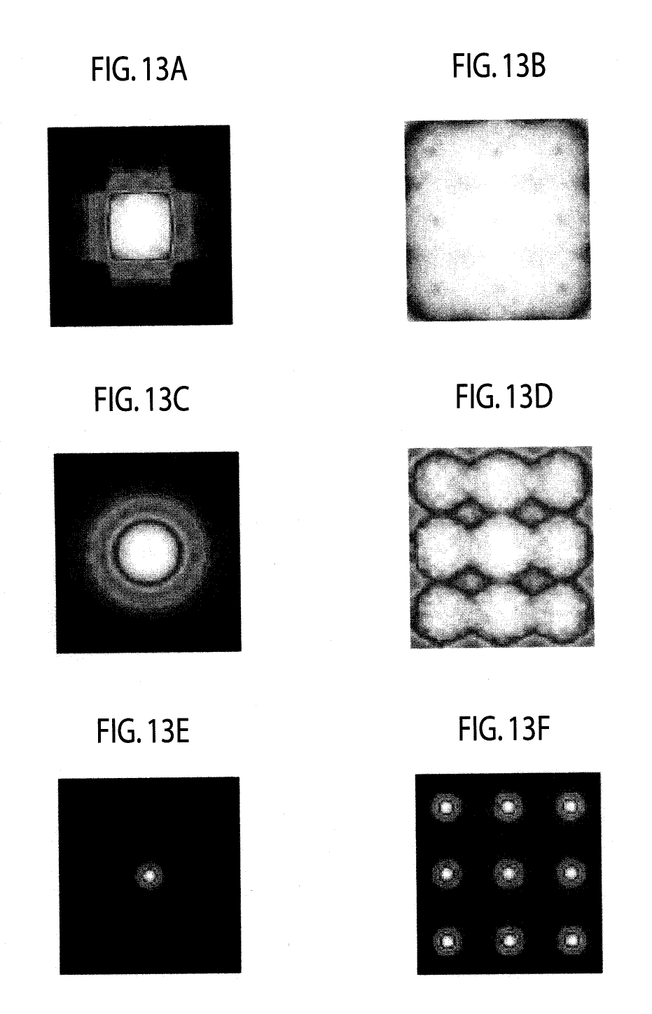

FIGS. 13A and 13B are luminance distribution diagrams at local areas of the surface light source unit having the light quantity control member of the second embodiment. FIGS. 13C and 13D are luminance distribution diagrams at local areas of the surface light source unit having the conventional light quantity control member. FIGS. 13E and 13F are luminance distribution diagrams at local areas of the surface light source unit having a diffusion plate having no light quantity control member.

FIGS. 13A, 13C and 13E show respective luminance distributions at a minimum area, while FIGS. 13B, 13D and 13F show respective luminance distributions at nine imaginary areas. The measurement was performed by using Pro Metric Color 1400 Luminance Measurement System made by Radiant Imaging Co. Ltd. in U.S.A.

When comparing the luminance distribution on a light emitting surface of the surface light source unit on the application of the light quantity control member 4a3 of the second embodiment with the luminance distribution on a light emitting surface of the surface light source unit on the application of the conventional light quantity control member, it is found that, in the former surface light source unit, the luminance unevenness is obviously resolved to attain the homogenization of luminance distribution in an effective luminous area, in comparison with the latter surface light source unit.

Note that the light mixing chamber 2 of the surface light source unit 11 with the conventional light quantity control member has a thickness of approx. 18 mm to attain the homogenization of luminance distribution, while the light mixing chamber 2 of the surface light source unit 11 with a diffusion plate in place of the conventional light quantity control member has a thickness of approx. 40 mm for the same purpose as the former chamber.

It is found that the luminance distribution at the minimum area spreads in a square manner, while the homogenization of luminance distribution is achieved in nine imaginary areas in the surface light source unit having the light quantity control member 4a3 of the second embodiment.

On the other hand, in the surface light source unit having the conventional light quantity control member, the luminance distribution at the minimum area spreads in a circular manner, so that the light from the LED 1 does not spread to four corners which are the farthest areas from the LED 1 in nine imaginary areas, sufficiently. It is also found that, in the surface light source unit having the diffusion plate, the light from the LED 1 does not spread as such due to narrowness of the spatial distance A between the LED 1 and the diffusion plate.

In addition to the above-mentioned effects of the first embodiment, according to the light quantity control member 4a3 with the cruciform diffusion patterns 42A to 42D of the second embodiment, even if the spatial distance A between the LEDs 1 and the light quantity control member 4 is remarkably small, in other words, the light mixing chamber 2 is formed remarkably thinly, there could be realized an effect of producing a square-shaped surface light source since the member 4a3 transmits respective light fluxes emitted from the LEDs 1 while diffusing them.

Also in the second embodiment, the light quantity control member 4a3 may be modified as the first and second modifications of FIGS. 7 and 8 in connection with the first embodiment, exhibiting the similar effects.

The present invention is applicable to all of illuminating devices besides the above-mentioned inland-type surface light source unit used in a liquid crystal display device, such as television and monitor. Finally, it will be understood by those skilled in the art that the foregoing descriptions are nothing but some embodiments and modifications of the disclosed light quantity control member (including the surface light source unit and the display device) and therefore, various further changes and modifications may be made within the scope of claims.

1. A light quantity control member comprising:
a substrate; and
a light diffusion part arranged on the substrate and also formed by a plurality of light diffusion members for diffusing light emitted from an external point-like light source, wherein
the light diffusion part includes: a first rectangular area positioned at the center of light flux emitted from the point-like light source; and second rectangular areas in the circumference of the first rectangular area, and wherein
the first rectangular area has the largest occupied area of the light diffusion members;
the second rectangular areas are respectively formed so that if respective distances between a center of the first rectangular area and respective centers of the second rectangular areas are equal to each other, then the occupied areas of the diffusion members of the second rectangular areas become equal to each other; and
each of the second rectangular areas is formed so that the longer the distance between the center of the first rectangular area and the center of the second rectangular area gets, the smaller the occupied area of the light diffusion members of the second rectangular area becomes.

2. The light quantity control member of claim 1, wherein
the second rectangular areas are arranged in a cross shape about the first rectangular area as a center.

3. The light quantity control member of claim 1, wherein
the light diffusion members are made from white ink.

4. A surface light source unit comprising:
a first point-like light source; and
a light quantity control member arranged above the first point-like light source to have a light diffusion part formed by a plurality of light diffusion members for diffusing light emitted from the first point-like light source, wherein
the light diffusion part includes: a first rectangular area positioned at the center of light flux emitted from the point-like light source; and second rectangular areas in the circumference of the first rectangular area, and wherein
the first rectangular area has the largest occupied area of the light diffusion members;
the second rectangular areas are respectively formed so that if respective distances between a center of the first rectangular area and respective centers of the second rectangular areas are equal to each other, then the occupied areas of the diffusion members of the second rectangular areas become equal to each other; and
each of the second rectangular areas is formed so that the longer the distance between the center of the first rectangular area and the center of the second rectangular area gets, the smaller the occupied area of the light diffusion members of the second rectangular area becomes.

5. The surface light source unit of claim 4, further comprising:
a second point-like light source arranged apart from the first point-like light source by a first distance in a first direction; and
a third point-like light source arranged apart from the first point-like light source by a second distance in a second direction different from the first direction, wherein:
the second rectangular areas include one rectangular area positioned in the first direction relative to the first rectangular area and another rectangular area positioned in the second direction relative to the first rectangular area; and
the second rectangular areas are arranged so that a distance between a center of the one rectangular area positioned in the first direction and the center of the first rectangular area gets shorter than a distance between a center of the other rectangular area positioned in the second direction and the center of the first rectangular area.

6. The surface light source unit of claim 4, further comprising a reflecting member opposed to the light quantity control member at a predetermined distance to reflect light, which has been diffused by the light quantity control member, against it.

7. A display device comprising:
a surface light source unit including:
a first point-like light source; and
a light quantity control member arranged above the first point-like light source to have a light diffusion part formed by a plurality of light diffusion members for diffusing light emitted from the first point-like light source, wherein the light diffusion part includes: a first rectangular area positioned at the center of light flux emitted from the point-like light source; and second rectangular areas in the circumference of the first rectangular area, and wherein
the first rectangular area has the largest occupied area of the light diffusion members;
the second rectangular areas are respectively formed so that if respective distances between a first center of the first rectangular area and respective second centers of the second rectangular areas are equal to each other, then the occupied areas of the diffusion members of the second rectangular areas become equal to each other; and
each of the second rectangular areas is formed so that the longer the distance between the first center of the first rectangular area and the second center of the second rectangular area gets, the smaller the occupied area of the light diffusion members of the second rectangular area becomes; and
a liquid crystal panel having a plurality of pixels to control light irradiated from the surface light source unit with respect to each pixel.

8. The display device of claim 7, wherein the surface light source unit further includes:
a second point-like light source arranged apart from the first point-like light source by a first distance in a first direction; and
a third point-like light source arranged apart from the first point-like light source by a second distance in a second direction different from the first direction, wherein:
the second rectangular areas include one rectangular area positioned in the first direction relative to the first rectangular area and another rectangular area positioned in the second direction relative to the first rectangular area; and
the second rectangular areas are arranged so that a distance between a center of the one rectangular area positioned in the first direction and the center of the first rectangular area gets shorter than a distance between a center of the other rectangular area positioned in the second direction and the center of the first rectangular area.

9. The display device of claim 7, wherein the surface light source unit further includes a reflecting member opposed to the light quantity control member at a predetermined distance to reflect light, which has been diffused by the light quantity control member, against it.
